(19) United States
(12) Patent Application Publication
(10) Pub. No.: US 2023/0381978 A1
(43) Pub. Date: Nov. 30, 2023

(54) PROCESSING MACHINE WITH ACTIVE VIBRATION REDUCTION

(71) Applicant: NIKON CORPORATION, Tokyo (JP)

(72) Inventors: Michael Birk BINNARD, Belmont, CA (US); Matthew Parker-McCormick BJORK, Oakland, CA (US); Yoon Jung JEONG, San Mateo, CA (US)

(73) Assignee: NIKON CORPORATION, Tokyo (JP)

(21) Appl. No.: 18/030,281

(22) PCT Filed: Sep. 28, 2021
(86) PCT No.: PCT/US2021/052426

§ 371 Date: Apr. 5, 2023

Related U.S. Application Data
(60) Provisional application No. 63/089,630, filed on Oct. 9, 2020.

(51) Int. Cl. B25J 17/02; B25J 19/00; B25J 11/00; B23K 26/36; F16F 15/023; F16F 15/027

(52) U.S. Cl. CPC B25J 17/0208; B25J 19/0091; B25J 11/005; B23K 26/36; F16F 15/023; F16F 15/0275; F16F 2228/066; F16F 2230/18; F16F 2230/0047

(57) ABSTRACT

A machine (10) for positioning an object (12) includes a movable part (16C) and a vibration reduction assembly (24) that couples the object (12) to the movable part (16C). Further, the vibration reduction assembly (24) reduces a magnitude of a vibration being transferred from the movable part (16C) to the object (12). The vibration reduction assembly (24) can include an actively controlled support system (30) and an actively controlled actuator system (32).

### RELATED APPLICATION

This application claims priority on U.S. Provisional Application No. 63/089,630 filed on Oct. 9, 2020, and entitled “PROCESSING MACHINE WITH ACTIVE VIBRATION REDUCTION”. As far as permitted the contents of U.S. Provisional Application No. 63/089,630 are incorporated in their entirety herein by reference.

### BACKGROUND

Machines are used in many industrial applications. One type of machine is a robot that includes a mechanical arm, e.g., a robotic arm, that positions a payload. There is a never-ending desire to improve the operation and positioning accuracy of robots.

### SUMMARY

The present implementation is directed to a machine for moving and positioning an object, the machine including a movable part and a vibration reduction assembly. The vibration reduction assembly couples the object to the movable part. Further, the vibration reduction assembly reduces a magnitude of a vibration being transferred from the movable part to the object. As a result thereof, the object can be positioned with improved accuracy. This, for example, allows for the manufacturing, processing, measurement, and/or assembly of components with improved precision. Further, the vibration reduction assembly can allow for a larger work envelope than the object may be able to commonly access with precision.

The movable part can be a link of a robot that includes a link actuator for moving the link. Further, the movable part can be a link of a multiple degree of freedom robotic arm, and the vibration reduction assembly inhibits vibration in multiple degrees of freedom. In alternative implementations, the movable part can be a vehicle such as an Automatically Guided Vehicle (AGV) or an aerial drone.

The vibration reduction assembly can include one or more low-stiffness supports that connect the object to the movable part. Each low-stiffness support can include a spring, a bellows, and/or a pneumatic chamber. Typically, the vibration reduction assembly includes a plurality of spaced apart low-stiffness supports that connect the object to the movable part. In one implementation, the force produced by each low-stiffness support is directed through a center of gravity of the object. Further, the low-stiffness supports can be arranged in a tetrahedron configuration. The low-stiffness supports can be arranged parallel to three perpendicular axes.

As used herein, in alternative, non-exclusive examples, the term “relatively soft” or “low stiffness” shall mean a stiffness of less than 1, 2, 5, 10, 20, 30, 50 or 100 Newton/millimeter. Stated in another fashion, as alternative, non-exclusive examples, low stiffness shall mean that the object will have a natural frequency of less than 1, 2, 5, or 10 hertz. Stated in yet another fashion, in certain implementations, “low stiffness” means the stiffness is at least at least five times lower than a stiffness of the movable part.

As used herein, in alternative, non-exclusive examples, the term “relatively high” or “high stiffness” shall mean a stiffness of greater than 100, 200, 500, or 1000 Newton/millimeter. Stated in another fashion, as alternative, non-exclusive examples, “relatively high” or “high stiffness” shall mean that the object has a natural frequency of greater than 10, 15, 20, or 50 hertz. In certain implementations, the term “relatively stiff” or “high stiffness” shall mean a stiffness of 10, 100, or 1000 times of “relatively soft” or “low stiffness”. It should be noted that other numbers for the factor are possible depending on the desired characteristics of the vibration reducer.

Additionally, a control system can actively control a force produced by each low-stiffness support.

Moreover, the vibration reduction assembly can include one or more controlled actuators that connect the object to the movable part. In one implementation, at least one support and at least one actuator act in parallel.

Further, a sensor assembly can provide feedback (“a sensed condition”), and a control system can actively control the vibration reduction assembly to inhibit vibration in the movable part from being transferred to the object. The type of sensed condition from the sensor assembly can include one or more of the following (i) the position, movement, orientation, velocity and/or acceleration of the object, (ii) the position, movement, orientation, velocity and/or acceleration of the movable part, and (iii) inertial points in space.

The movable part can be a component of a processing machine. For example, the movable part can be a component of a laser processing machine, and the object can be a laser device. For example, the movable part can be a mobile robotic vehicle. For example, the movable part can be a mobile vehicle driven by an onboard or remote operator. For example, the movable part can be an aerial drone. For example, the movable part can be an aerial vehicle driven by an onboard or remote operator.

In another implementation, a robotic assembly for positioning a payload includes a robot and the vibration reduction assembly. The robot includes a link and a link actuator that selectively moves the link. The vibration reduction assembly couples the payload to the robot. The vibration reduction assembly at least partly inhibits vibration in the robot from being transferred to the payload. The robot can include a multiple degree of freedom robotic arm, and the vibration reduction assembly can inhibit vibration in multiple degrees of freedom.

In another implementation, a vibration reduction assembly that couples an object to a movable part includes (i) a plurality of spaced apart low-stiffness supports that couple the object to the movable part; (ii) a sensor assembly that provides feedback; and (iii) a control system that actively controls the low-stiffness supports to at least partly inhibit vibration in the movable part from being transferred to the object using the feedback. For example, the sensor assembly can provide feedback regarding a sensed condition, such as (i) the position, orientation, velocity and/or acceleration of the object, and/or (ii) the position, orientation, velocity and/or acceleration of the movable part; and/or (iii) an inertial reference frame or object,

The control system can actively control the low-stiffness supports to partly inhibit vibration in the movable part from being transferred to the object with six degrees of freedom. Further, each low-stiffness support can include a pneumatic chamber. Moreover, the control system can actively control a force produced by each low-stiffness support.

In certain implementations, the force produced by each low-stiffness support is directed through a center of gravity of the object.

The low-stiffness supports can be arranged in a tetrahedron or other configuration.

The vibration reduction assembly can also include a plurality of spaced apart actuators that connect the object to the movable part. Further, the control system can actively control the actuators to inhibit vibration in the movable part from being transferred to the object.

Additionally, the vibration reduction assembly can include a first connector frame that is secured to the movable part, and a second connector frame that retains the object. In this design, the plurality of spaced apart low-stiffness supports extend between the first connector frame and the second connector frame.

In still another implementation, the vibration reduction assembly includes: a plurality of supports which movably couple the movable part to the object; a sensor assembly that obtains information regarding a sensed condition of the object; and a control system that actively controls the supports to reduce the magnitude of the vibration from the movable part to the object.

In yet another implementation, the laser machine includes: a laser including a laser output; a robot; and a vibration reduction assembly that couples the laser output to the robot, the vibration reduction assembly reducing a magnitude of a vibration being transferred from the robot to the laser output.

### BRIEF DESCRIPTION OF THE DRAWINGS

The novel features of this embodiment, as well as the embodiment itself, both as to its structure and its operation, will be best understood from the accompanying drawings, taken in conjunction with the accompanying description, in which similar reference characters refer to similar parts, and in which:

FIG. 1A is a simplified perspective view of a first implementation of a machine that includes an payload, a robot, and a vibration reduction assembly;

FIG. 1B is a perspective view of the payload, the vibration reduction assembly, and a portion of a robot of FIG. 1A;

FIG. 1C is a perspective view of the payload and a portion of the vibration reduction assembly from FIG. 1B;

FIG. 1D is an alternative perspective view of the payload and the portion of the vibration reduction assembly of FIG. 1C;

FIG. 1E is a perspective view of a connector frame and a portion of the vibration reduction assembly of FIG. 1B;

FIG. 2 is a perspective view of another implementation of the payload, the vibration reduction assembly, and a portion of the robot;

FIG. 3A is a simplified perspective view of another implementation of a machine that includes the payload, the robot, and the vibration reduction assembly;

FIG. 3B is a perspective view of the payload, the vibration reduction assembly, and a portion of a robot of FIG. 3A;

FIG. 3C is a perspective view of a portion of the robot and a portion of the vibration reduction assembly of FIG. 3B;

FIG. 3D is a perspective view of a portion of the vibration reduction assembly and the payload of FIG. 3B;

FIG. 3E is a side view of a portion of the robot and a portion of the vibration reduction assembly of FIG. 3B;

FIG. 3F is a bottom view of the portion of the robot and the portion of the vibration reduction assembly of FIG. 3B;

FIG. 3G is a perspective view of the portion of the robot and the portion of the vibration reduction assembly of FIG. 3B;

FIG. 4 is a non-exclusive implementation of a control block diagram for controlling the vibration reduction assembly;

FIGS. 5A-5D are alternative perspective views of another implementation of the first connector frame;

FIGS. 5E-5H are alternative perspective views of another implementation of the second connector frame;

FIG. 6 is a simplified side view of another implementation of a machine; and

FIG. 7 is a simplified side view of still another implementation of a machine.

### DESCRIPTION

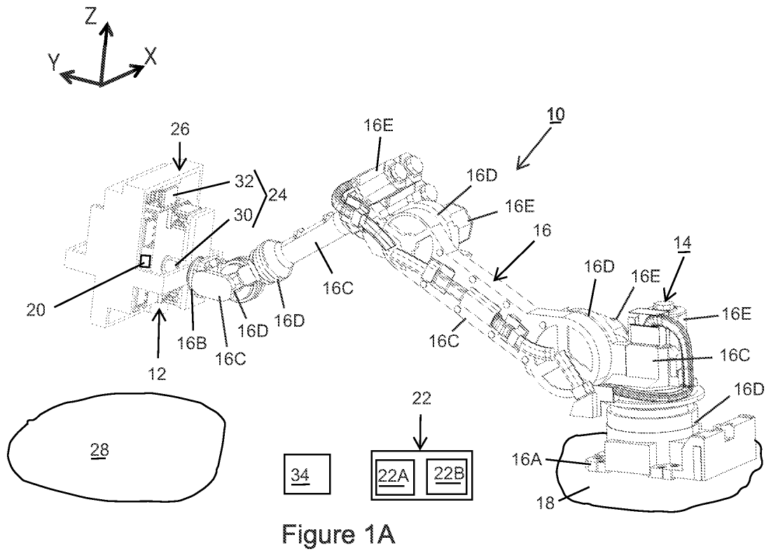

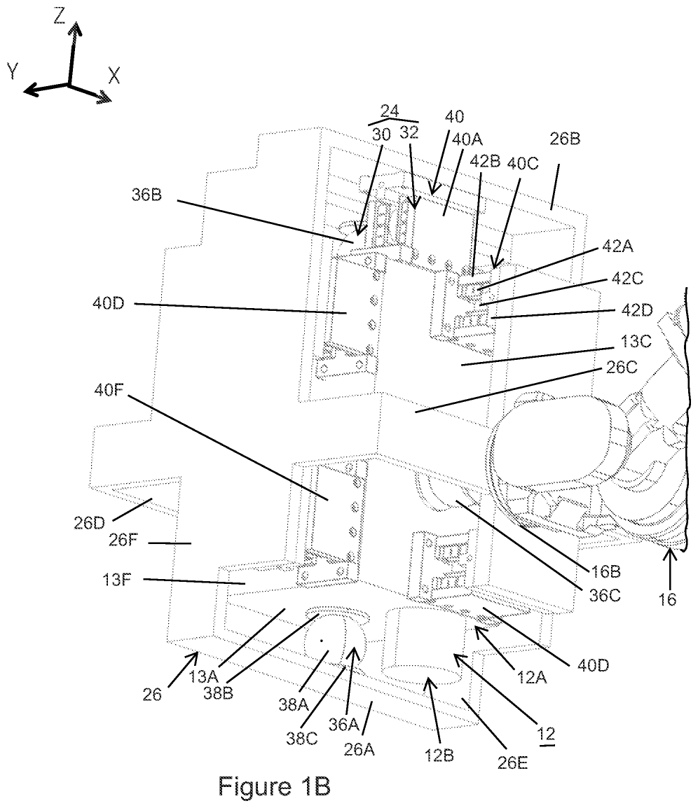

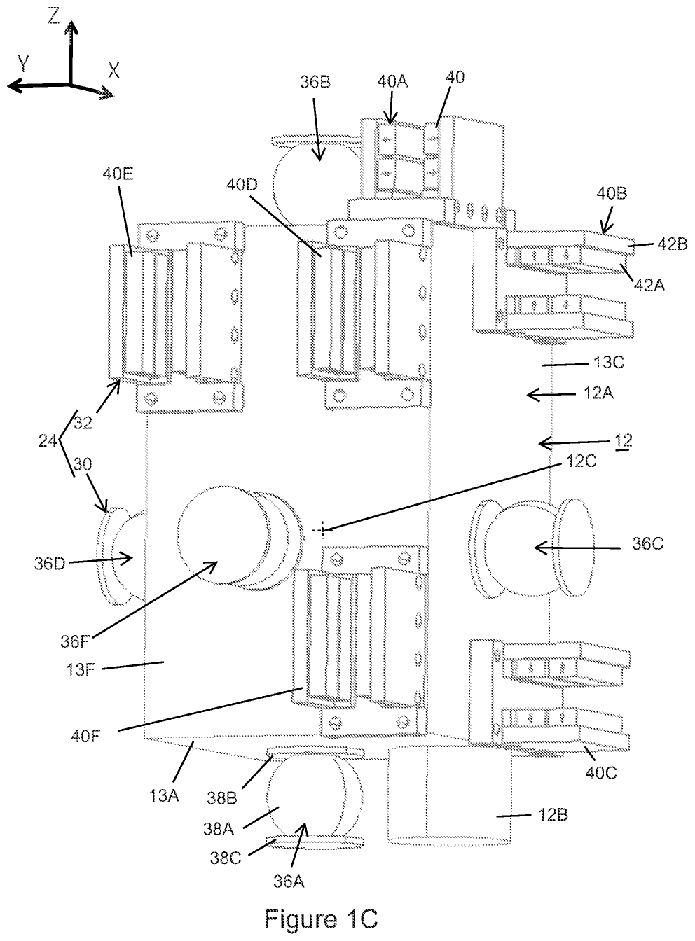

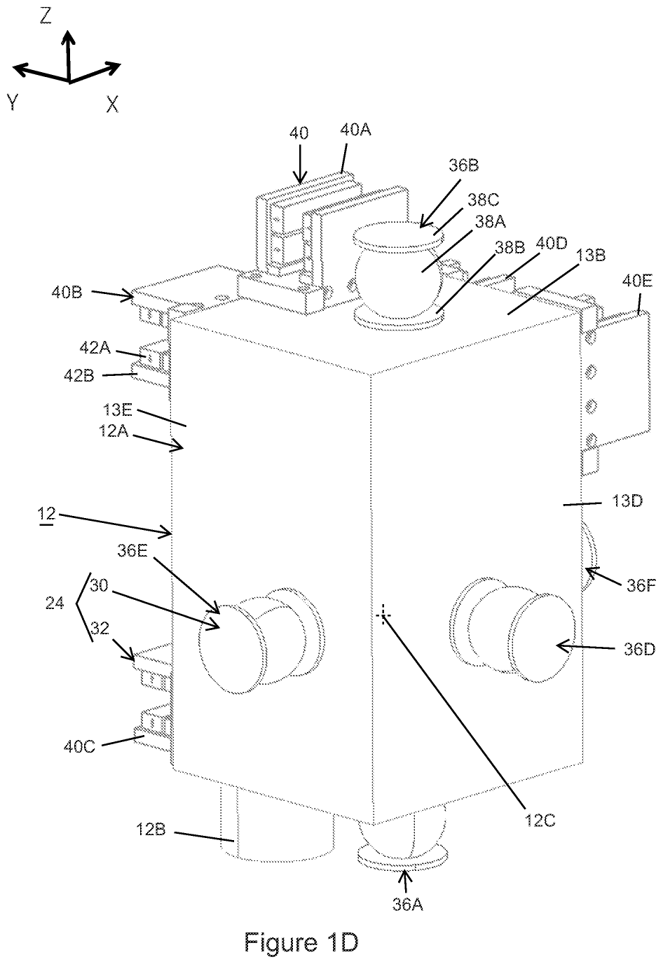

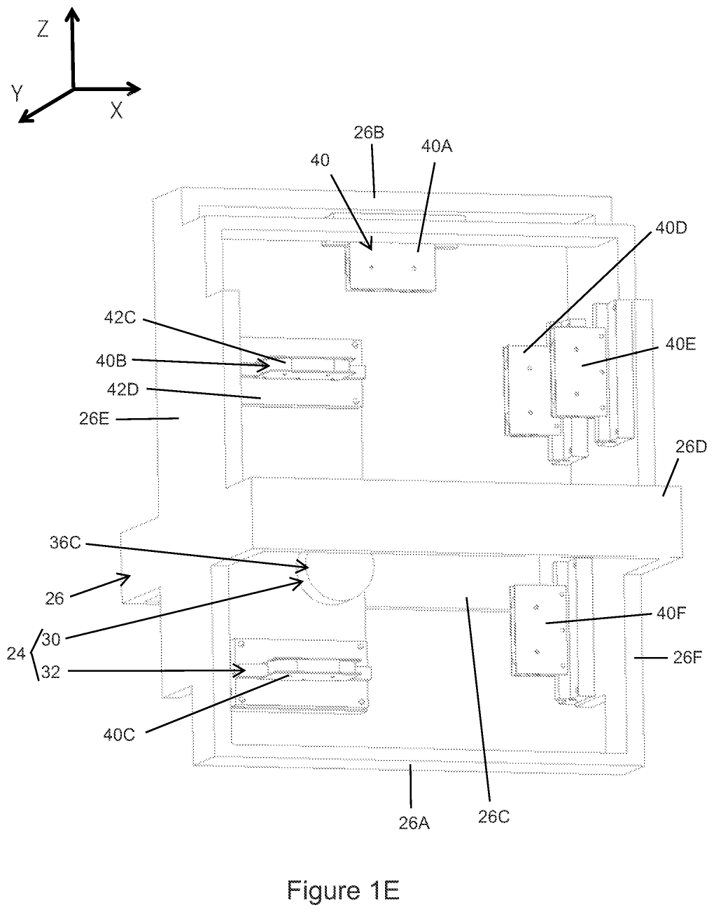

FIG. 1A is a simplified perspective view of a machine 10 that is programmable and controllable to carry out one or more complex actions. In FIG. 1A, the machine 10 includes an object 12, and an assembly 14 that moves and positions the object 12. In this implementation, the object 12 is an optical instrument (e.g., a measurement or processing device), and the assembly 14 is a robotic assembly that includes a robot 16 that is supported by a support 18, a sensor assembly 20 (illustrated as a box), a control system 22 (illustrated as a box), and a vibration reduction assembly 24 that cooperate to accurately position the object 12. The robot 16 is not limited to anthropomorphic robot or selective compliance assembly robot arm robot. Furthermore, the robot may also be a serial link robot such as a rectangular robot, a cylindrical robot or a polar robot, parallel link robot or other type of robot. It should be noted that the number and design of the components of the machine 10, and the assembly 14 can be varied to achieve the task(s) to be performed by the machine 10. Further, it should be noted that the machine 10 can be another type of processing machine other than a robotic assembly with a robotic arm. As alternative, non-exclusive examples, the vibration reduction assembly 24 can be used in a conventional processing machine (e.g. a laser processing machine or a machining center) or a transport machine (e.g., an automated guided vehicle or aerial drone).

As non-exclusive examples, the vibration can be generated by (i) the support 18, (ii) other components that engage the support 18, (iii) actuators, links, cables, or wiring in the assembly 14, (iv) the wind; and/or (v) acoustic noise.

A plurality of different implementations are disclosed herein. As an overview, in each implementation, the vibration reduction assembly 24 is uniquely designed to reduce a magnitude of the vibration being transferred from the robot 16 and/or the support 18 to the object 12. As a result thereof, the object 12 can be positioned with improved accuracy. This, for example, allows for the manufacturing, measurement, processing, gripping, and/or assembly of components with improved precision. The amount of vibration reduction can be varied according to the design of the system. As alternative, non-exclusive examples, the vibration reduction assembly 24 can reduce the magnitude of the vibration at least approximately 20, 30, 40, 50, 60, 70, 80, or 90 percent.

It should be noted that the control system 22 is illustrated as a single system that is part of the larger assembly 14 and that controls both the robot 16 and the vibration reduction assembly 24. Alternatively, the control system 22 can be a distributed system, with a separate control system that is part of and controls the robot 16, and another control system that is part of and controls the vibration reduction assembly 24. Similarly, the sensor assembly 20 is illustrated as a single system that is part of the larger assembly 14 and that provides feedback for the control of both the robot 16 and the vibration reduction assembly 24. Alternatively, the sensor assembly 20 can include multiple different, spaced apart sensors that provide feedback used for the control of the robot 16, and multiple additional, spaced apart sensors that provide feedback used for the control of the vibration reduction assembly 24. In certain designs, the sensor assembly 20, the control system 22, and the support adjuster 34 (described below) can be considered part of the vibration reduction assembly 24.

The term “vibration” as used herein shall mean and include steady-state vibration, short term disturbances, random disturbances, transient disturbances, repeatable disturbances, and any unwanted motion.

A number of Figures include an orientation system that illustrates an X axis, a Y axis that is orthogonal to the X axis, and a Z axis that is orthogonal to the X and Y axes. It should be noted that any of these axes can also be referred to as the first, second, and/or third axes. Further, movement along or about a single axis can be referred to as a one degree of freedom, and movement along and about the X, Y and Z axes can be referred to as six degrees of freedom.

The size, shape and design of the object 12 can be varied to achieve the task the machine 10 is designed to perform. In FIG. 1A, the object 12 is an optical instrument that is designed to interact with a target workpiece. As non-exclusive examples, the object 12 can be a device for performing a desired task such as welding, cutting, measuring, soldering, manufacturing, cladding, grooving, depositing material, ablating material, gripping, spinning, placement, or fastening. For example, the object 12 can be an optical instrument, such as a laser device, and the desired task can be (i) precisely cutting or removing one or more grooves (not shown) in one or more components (not shown); (ii) welding one or more components; and/or (iii) soldering one or more components. Alternatively, for example, the object 12 can be a gripper (e.g. a robotic hand) and the desired task is moving and/or positioning an object (not shown).

In a specific example, the object 12 is a laser or a portion of the laser (not the entire laser). As examples, the portion of the laser can be a laser output, a portion of an optical fiber that launches (emits) a laser beam, and a laser optical output, the gain medium of the laser, and/or a laser beam steering assembly. It is enough to include at least a part or an optical element for laser output. The laser light source may be separated from object 12. For example, the laser light source may be located around the support 18 or other place and linked to object 12 via an optical fiber element.

The term “object” can also be referred to as a “payload”. It should be noted that the design of the vibration reduction assembly 24 can be adjusted to suit also any sized or shaped payload.

As provided above, the robot 16 is supported by the support 18. As non-exclusive examples, the support 18 can be a floor, a wall, or other fixed surface in a factory, inside a building, or outside. Alternatively, the support 18 can be a movable structure.

The robot 16 moves and positions the payload 12. The design of the robot 16 can be varied to suit the movement requirements of the payload 12. In the non-exclusive implementation of FIG. 1A, the robot 16 is a multiple degree of freedom robotic (mechanical) arm having a base 16A that is fixedly secured to the support 18, and a mount 16B that is connected by the vibration reduction assembly 24 to the payload 12. As alternative, non-exclusive examples, the robot 16 can be designed and controlled to move and position the payload 12 with at least one, two, three, four, five, or six degrees of freedom relative to the support 18. It should be noted that the robotic arm 16 can be part of a more complex robot (not shown) that moves relative to the support 18. In FIG. 1A, the mount 16B is at a distal end (when referenced to the base 16A) of the robot 16. Alternatively, the mount 16B can be at another location.

The robot 16 can include one or more rigid links 16C, one or more joints 16D, and one or more link actuators 16E (only a few are labeled with reference numbers). The links 16C are connected by joints 16D that allow for either rotational motion or translational movement, and the link actuators 16E are controlled to rotationally and/or translationally move the links 16C. It should be noted that (i) any of the links 16C can be referred to as a first, second, third, fourth, etc. link; (ii) any of the joints 16D can be referred to as a first, second, third, fourth, etc. joint; and (iii) any of the link actuators 16E can be referred to as a first, second, third, fourth, etc. link actuator. For example, each link actuator 16E can include one or more linear actuators and/or one or more rotational actuators.

The links 16C of the robot 16 can be considered a kinematic chain, and the control system 22 can control the link actuators 16E to position the payload 12 with one or more degrees of freedom. In the non-exclusive implementation of FIG. 1A, the robot 16 can position the payload 12 with six degrees of freedom to position the payload 12 at any arbitrary position and orientation in three-dimensional space.

In one implementation, the mount 16B of the robot 16 can include a connector frame 26 that provides a rigid structure for (i) supporting the vibration reduction assembly 24, (ii) connecting the vibration reduction assembly 24 to the robot 16, and (iii) properly positioning the vibration reduction assembly 24 for vibration reduction of the payload 12. The size, shape, and design of the connector frame 26 can be varied according to the design of the vibration reduction assembly 24 and the payload 12. One non-exclusive design of the connector frame 26 is discussed in more detail with reference to FIGS. 1B and 1C.

It should be noted that the one or more links 16C, one or more joints 16D and/or the connector frame 26 can be referred to generically as a “movable part”.

Further, it should also be noted that the connector frame 26 can alternatively be discussed as being a part of the vibration reduction assembly 24. In this discussion, the connector frame 26 can be physically connected to a distal link or a distal joint near the mount 16B of the robot 16.

Moreover, it should be noted that the industrial robotic assembly 14 can be subjected to some amount of vibration disturbance from the support 18. Because of the mechanical dynamics of the robotic assembly 14, some of those vibrations are transmitted to the connector frame 26. Additionally, the robotic assembly 14 itself may add additional vibration modes. Still further, disturbance forces from air currents (i.e., wind), acoustic noise, and cables or hoses may act on object 12. As discussed below, the vibration reduction assembly 24 inhibits this vibration from being transmitted to the object 12 and counteracts the effects of these disturbances.

The sensor assembly 20 senses (i) the position, velocity, and/or acceleration of the payload 12, and/or (ii) the position of one or more components of the vibration reduction assembly 24, and/or (iii) the position, velocity, and/or acceleration of the moving part (e.g. the robot 16), and provides feedback that is used by the control system 22 to control the link actuators 16E of the robot 16 and the vibration reduction assembly 24. The design of the sensor assembly 20 can be varied to provide the desired feedback to control the link actuators 16E and the vibration reduction assembly 24. For example, if the robot 16 positions the payload 12 with six degrees of freedom, it may be desirable for the sensor assembly 20 to provide feedback regarding all six degrees of freedom. In the non-exclusive example of FIG. 1A, the sensor assembly 20 can provide feedback regarding the position of the payload 12 with six degrees of freedom relative to a target surface 28 and/or the connector frame 26. As non-exclusive examples, the sensor assembly 20 can include one or more cameras that function at one or more wavelengths, interferometers, photodetectors, or non-optical measurement devices such as accelerometers, ultrasonic, eddy current, or capacitive sensors.

The control system 22 controls the components of the machine 10. For example, the control system 22 can control (i) the payload 12; (ii) the robot 16; (iii) the sensor assembly 20; and (iv) the vibration reduction assembly 24. The control system 22 can be a centralized or distributed system.

The control system 22 may include, for example, a CPU (Central Processing Unit) 22A, and electronic memory 22B. The control system 22 functions as a device that controls the operation of the machine 10 by the CPU executing the computer program. The control system 22 may not be disposed inside the machine 10, and may be arranged as a server or the like outside the machine 10, for example. In this case, the control system 22 and the machine 10 may be connected via a communication line such as a wired communications line (cable communications), a wireless communications line, or a network. Furthermore, each processing and function included in the program may be executed by program software that can be executed by a computer, or processing of each part may be executed by hardware such as a predetermined gate array (FPGA), ASIC, or program software, and a partial hardware module that realizes a part of hardware elements may be implemented in a mixed form.

The programming and the hardware for the control system 22 can be varied to achieve the desired task that the machine 10 will be performing.

The vibration reduction assembly 24 connects (directly or indirectly) the payload (object) 12 to the robot (movable part) 16, and extends between the payload 12 and connector frame 26 of the robot 16. Further, the vibration reduction assembly 24 reduces (inhibits) vibration in the robot 16 (e.g. in the connector frame 26, links 16C, joints 16D, and link actuators 16E) and the support 18 from being transferred to the payload 12. The vibration reduction assembly 24 may also counteract disturbance forces that act on the payload 12. As a result thereof, for example, the robotic assembly 14 can, together with the vibration reduction assembly 24, more accurately position the payload 12 relative to the target surface 28. A number of different implementations of the vibration reduction assembly 24 are disclosed herein.

The design of the vibration reduction assembly 24 can be varied to suit the design and movement requirements of the payload 12. In alternative designs, (i) if the robot 16 is designed to position the payload 12 with one degree of freedom, the vibration reduction assembly 24 can be designed to inhibit vibration of the payload 12 in at least one degree of freedom; (ii) if the robot 16 is designed to position the payload 12 with two degrees of freedom, the vibration reduction assembly 24 can be designed to inhibit vibration of the payload 12 in at least two degrees of freedom; (iii) if the robot 16 is designed to position the payload 12 with three degrees of freedom, the vibration reduction assembly 24 can be designed to inhibit vibration of the payload 12 in at least three degrees of freedom; (iv) if the robot 16 is designed to position the payload 12 with four degrees of freedom, the vibration reduction assembly 24 can be designed to inhibit vibration of the payload 12 in at least four degrees of freedom; (v) if the robot 16 is designed to position the payload 12 with five degrees of freedom, the vibration reduction assembly 24 can be designed to inhibit vibration of the payload 12 in at least five degrees of freedom; or (vi) if the robot 16 is designed to position the payload 12 with six degrees of freedom, the vibration reduction assembly 24 can be designed to inhibit vibration of the payload 12 in six degrees of freedom. It should be noted that the robot 16 and the vibration reduction assembly 24 can be designed so that the degrees of freedom of the robot 16 are different from the degrees of freedom reduction of the vibration reduction assembly 24. As a non-exclusive example, the robot 16 can be designed to have one degree of movement, and the vibration reduction assembly 24 can be designed to have reduction of more than one (e.g. two, three, four, five, or six) degrees of freedom. As yet another example, the robot 16 can be designed to have six degrees of freedom, and the vibration reduction assembly 24 can be designed to have reduction in less than six (e.g. five, four, three, two, or one) degrees of freedom.

In the non-exclusive implementation of FIG. 1A, the vibration reduction assembly 24 includes a low stiffness support system 30, and an actuator system 32. With this design, the problem of providing a high performance vibration isolating wrist for an industrial robot 16 performing a precision operation is solved by using a vibration reduction assembly 24 that includes an actively or passively controlled low-stiffness support system 30, and an actively controlled, actuator system 32 between the robot 16 and the payload 12 to improve force control performance. In this design, the support system 30 and an actuator system 32 act in parallel to isolate the payload 12 from vibration. Further, as non-exclusive examples, the actuator system 32 can be controlled to respond at least 2, 5, 8 or 10 times faster than the support system 30 to vibration. Thus, the actuator system 32 will have a higher bandwidth than the support system 30. Alternatively, for example, the vibration reduction assembly 24 might be designed without the actuator system 32 or without the support system 30.

It should be noted that the support system 30 can include a support adjuster 34 (illustrated as a box) that is controlled by the control system 22 to actively adjust the support system 30. The support adjuster 34 is discussed in more detail below.

FIG. 1B is an enlarged, perspective view of (i) a portion of the robot 16 including the mount 16B with the connector frame 26; (ii) the payload 12; and (iii) the vibration reduction assembly 24 of FIG. 1A. In this design, the connector frame 26 can attach the vibration reduction assembly 24 and the payload 12 to the robot 16. Stated in another fashion, the connector frame 26, the vibration reduction assembly 24 and the payload 12 can function as a module that can be added to the robot 16 or another processing machine.

FIGS. 1C and 1D are alternative perspective views of the payload 12 and a portion of the vibration reduction assembly 24 from FIG. 1A.

As provided above, the size, shape and design of the payload 12 can be varied. In the non-exclusive example illustrated in FIGS. 1B, 1C and 1D, the payload 12 is a laser device that includes a generally rectangular box shaped payload body 12A, and a generally cylindrical shaped laser output 12B that launches the laser beam. For example, the laser output 12B can include one or more optical fibers and/or lenses. Further, the payload 12 has a payload center of gravity 12C (illustrated with a small dashed cross in FIGS. 1C and 1D). The payload center of gravity 12 can also be referred to as a payload or object center of gravity.

In the implementation of FIGS. 1B-1D, the rectangular payload body 12A includes six rigid sides, which can be labeled (i) a first payload side 13A, (ii) a second payload side 13B, (iii) a third payload side 13C, (iv) a fourth payload side 13D, (v) a fifth payload side 13E, and (vi) a sixth payload side 13F for convenience of discussion. In this example, the second payload side 13B is opposed and spaced apart from the first payload side 13A, and the third, fourth, fifth and sixth payload sides 13C-13F extend between the first payload side 13A and the second payload side 13B.

FIG. 1E is a perspective view of the connector frame 26 and a portion of the vibration reduction assembly 24 of FIG. 1A.

With reference to FIGS. 1B and 1E, in this implementation, the connector frame 26 provides the rigid structure for supporting and positioning the support system 30 and the actuator system 32 for vibration reduction of the payload 12. Further, the connector frame 26 directly and physically connects the support system 30 and the actuator system 32 to robot 16.

In the non-exclusive implementation of FIGS. 1B and 1E, the connector frame 26 is somewhat open rectangular, rigid frame shaped and includes six rigid sides, which can be labeled (i) a first frame side 26A, (ii) a second frame side 26B, (iii) a third frame side 26C, (iv) a fourth frame side 26D, (v) a fifth frame side 26E, and (vi) a sixth frame side 26F for convenience of discussion. In this example, (i) the first frame side 26A is opposed and spaced apart from the second frame side 26B, (ii) the fifth frame side 26E and the sixth frame side 26F extend between the first frame side 26A and the second frame side 26B, and (iii) the third frame side 26C and the fourth frame side 26D extend between the fifth frame side 26E and the sixth frame side 26F. In this non-exclusive implementation, the connector frame 26 encircles payload 12.

As provided above, with reference to FIGS. 1B-1E, the vibration reduction assembly 24 can include the actively controlled low stiffness support system 30, and the actively controlled actuator system 32. The design of each of these systems 30, 32 can be varied to achieve the desired vibration reduction of the payload 12.

The actively controlled low-stiffness support system 30 extends between the connector frame 26 and the payload 12. In this design, the support system 30 supports a mass of the payload 12 and isolates the payload 12 from high frequency external disturbances. The design of the support system 30 can be varied. For example, the support system 30 can include one or more low-stiffness supports 36 that extend directly between the connector frame 26 and the payload 12; and the support adjuster 34 (illustrated in FIG. 1A) can selectively adjust one or more of the low stiffness supports 36. The coupling between the payload 12 and support system 30 may be a contact type or a non-contact type coupling. The payload 12 may be supported by support system 30 in-directly. For example, the payload 12 may be levitated and supported by magnetic force, suction force or other type of force. Alternatively another other component may be arranged between payload 12 and support system 30, and such the component may couple with payload 12.

In the non-exclusive implementation in FIGS. 1B-1E, the support system 30 includes six spaced apart, low-stiffness supports 36 that each extend between the connector frame 26 and the payload 12. In this design, there is one support 36 for each of the six payload sides. For convenience, these supports 36 can be labeled (i) a first support 36A that extends between the first frame side 26A and the first payload side 13A; (ii) a second support 36B that extends between the second frame side 26B and the second payload side 13B; (iii) a third support 36C that extends between the third frame side 26C and the third payload side 13C; (iv) a fourth support 36D that extends between the fourth frame side 26D and the fourth payload side 13D; (v) a fifth support 36E that extends between the fifth frame side 26E and the fifth payload side 13E; and (vi) a sixth support 36F that extends between the sixth frame side 26F and the sixth payload side 13F.

In this design, (i) the first support 36A and the second support 36B are aligned along the Z axis through the payload center of gravity 12C; (ii) the third support 36C and the fourth support 36D are aligned along the Y axis through the payload center of gravity 12C; and (iii) the fifth support 36E and the sixth support 36F are aligned along the X axis through the payload center of gravity 12C. With this design, the six supports 36A-36F are aligned with the payload center of gravity 12C, and the support system 30 supports the payload 12 through the payload center of gravity 12C along the X, Y, and Z axes. Stated in another fashion, the supports 36 are positioned so their force acts through the center of gravity 12C of the payload 12.

The design each support 36 can be varied. For example, each support 36 can be a fluid or air balloon, gas spring, piston, or bellows. In one non-exclusive implementation, each support 36 can include (i) a compliant pneumatic chamber 38A that is filled with a pneumatic fluid; (ii) a first support pad 38B that connects the chamber 38A to the payload 12; and (iii) a second support pad 38C that connects the chamber 38A to the connector frame 26. Further, one or more (e.g. each) of the supports 36 can include a pressure sensor (not shown) which senses the pressure of the pneumatic fluid in the respective pneumatic chamber 38A. The support 36 can alternatively be referred to as a shock absorber, a buffer, a bumper, or a dumper.

With this design, the pressure sensor for each support 36 can provide feedback regarding the pressure in each support 36 to the control system 22 (illustrated in FIG. 1A), and the control system 22 can actively control the support adjuster 34 (illustrated in FIG. 1A) to individually and actively adjust and control the pressure in the chamber 38A of each support 36. This active control of the pressure of the pneumatic fluid in each chamber 38A also actively controls the force produced by each support 36. The support adjuster 34 can include one or more electronic regulators, servo valves, pumps and reservoirs to individually add and remove pneumatic fluid to each chamber 38A under the control of the control system 22 to control of the pressure in each chamber 38A.

With this design, an external disturbance transferred to the connector frame 26 will cause the connector frame 26 to move. The movement of the connector frame 26 will cause the pressure in one or more of the chambers 38A to change (fluctuate). The pressure sensors can detect these changes, and the feedback is used to control the support adjuster 34 to individually control the pressure in each chamber 38A (e.g. minimize pressure fluctuation) to inhibit the external disturbance from being transmitted to the payload 12. Further, the support adjuster 34 can individually control the pressure in each chamber 38A to address changes in the gravity vector caused by the robot 16 orienting the object 12 at any angle with respect to gravity. Alternatively, or additionally, the actuator system 32 described below can address the changes in the gravity vector.

The optional, actively controlled, actuator system 32 extends between the connector frame 26 of the robot 16 and the payload 12. In this design, the actuator system 32 actively generates one or more controllable forces on the payload 12 to further isolate the payload 12 from external disturbances. The control system 22 (illustrated in FIG. 1A) can actively control the actuator system 32 using feedback from the sensor assembly 20 (illustrated in FIG. 1A) to counteract external disturbances and the internal disturbances. The actuator system 32 provides reduction of higher bandwidth disturbances.

The design of the actuator system 32 can be varied. For example, the actuator system 32 can include one or more actuators 40 that extend between the connector frame 26 and the payload 12. Further, one or more of the actuators 40 can act in parallel with one or more of the low-stiffness supports 36. In addition, the actuator system might make use of inertial reaction masses to exert forces on the system.

In the non-exclusive implementation in FIGS. 1B-1E, the actuator system 32 includes six spaced apart actuators 40 that each extend between the connector frame 26 and the payload 12. For convenience, these actuators 40 can be labeled (i) a first actuator 40A that extends between the second frame side 26B and the second payload side 13B; (ii) a second actuator 40B that extends between the third frame side 26C and the third payload side 13C; (iii) a third actuator 40C that extends between the third frame side 26C and the third payload side 13C; (iv) a fourth actuator 40D that extends between the sixth frame side 26F and the sixth payload side 13F; (v) a fifth actuator 40E that extends between the sixth frame side 26F and the sixth payload side 13F; and (vi) a sixth actuator 40F that extends between the sixth frame side 26F and the sixth payload side 13F.

In this design, (i) the first actuator 40A generates a controllable force along the Z axis on the payload 12; (ii) the second actuator 40B and the third actuator 40C each generate a separate, individually controllable force along the Y axis on the payload 12; and (iii) the fourth actuator 40D, the fifth actuator 40E, and the sixth actuator 40F each generate a separate, individually controllable force along the X axis on the payload 12.

Further, the Y axis forces generated by the second actuator 40B and the third actuator 40C are spaced apart along the Z axis (e.g. on opposite sides of payload center of gravity 12C), and the Y axis forces can be used to generate a controllable rotational force on the payload 12 about the X axis. Moreover, the X axis forces generated by the fourth actuator 40D and the fifth actuator 40E are spaced apart along the Y axis (e.g. on opposite sides of payload center of gravity 12C), and these X axis forces can be used to generate a controllable rotational force on the payload 12 about the Z axis. Somewhat similarly, the X axis forces generated by the fourth actuator 40D and the sixth actuator 40F are spaced apart along the Z axis (e.g. on opposite sides of payload center of gravity 12C), and these X axis forces can be used to generate a controllable rotational force on the payload 12 about the Y axis. With this design, the actuators 40 can be controlled to position the payload 12 with six degrees of freedom.

The design each actuator 40 can be varied. For example, each actuator 40 can be a voice coil actuator, a linear actuator, rotational actuator, variable reluctance actuator or another type of actuator. In one non-exclusive implementation, each actuator 40 is a voice coil actuator that includes (i) a magnet array 42A, (ii) a magnet bracket 42B that retains the magnet array 42A, (iii) a conductor array 42C, and (iv) a conductor bracket 42D that retains the conductor array 42C.

In FIGS. 1B-1E, (i) the magnet array 42A and magnet bracket 42B are secured to and move with the payload 12, and (ii) the conductor array 42C and the conductor bracket 42D are secured to and move with the connector frame 26. Alternatively for each actuator 40, the conductor array 42C can be connected to the payload 12 and the magnet array 42A can be connected to the connector frame 26.

Moreover, in the non-exclusive implementation of FIGS. 1B-1E, (i) the magnet array 42A includes a pair of spaced apart magnet sets, (ii) the magnet bracket 42B has a generally square, “U” shaped cross-section, (iii) the conductor array 42C includes a single conductor array, and (iv) the conductor bracket 42D has a generally “T” shaped cross-section. However, other designs are possible.

Additionally, the sensor assembly 20 (illustrated in FIG. 1A) can include a sensor (not shown) which measures (i) the relative position, velocity, acceleration of the magnet array 42A and the conductor array 42C of each actuator 40; and/or (ii) measure six degree of freedom attitude of the payload 12 relative to something; and/or (iii) the relative position, velocity, acceleration of the moving part.

The number of sensors and/or the position of the sensors can be varied. With this design, the sensor assembly 20 can generate feedback regarding the relative position the magnet array 42A and the conductor array 42C of each actuator 40, in addition to the feedback regarding the position of the payload 12 and/or the position of the moving part. This feedback can be used by the control system 22 (illustrated in FIG. 1A) to actively control (direct electrical current) to the actuators 40 to individually and actively adjust the force generated by each actuator 40. This active control of the force by each actuator 40 can be used to constantly maintain the position of the payload 12 under the control of the control system 22.

It should be noted that the sensor assembly 20 is not limited to measure the relative position of the magnet array 42A and the conductor array 42C. For example, the sensor assembly 20 can include one or more sensors that are arranged to measure six degrees of freedom attitude of the payload 12 relative to the moving part. The number of sensors and the position of sensors required to monitor the six degrees of freedom attitude of the payload 12 can be varied. The feedback can be used to actively control the force by each actuator 40.

As provided herein, an external disturbance transferred to the connector frame 26 will cause the connector frame 26 to move. Simultaneously, the force by each actuator 40 can be actively adjusted to maintain the desired position of the payload 12. With this design, the plurality of higher bandwidth actuators 40 can be controlled to improve force control performance. The force from these actuators 40 can be used in conjunction with or in place of controlling the air pressure in the supports 36.

Thus, to provide a high precision stable operation of the payload 12, the vibration reduction assembly 24 allows the robot 16 to position the payload 12 in space while isolating it from unwanted vibration and position errors of the robot 16, and while counteracting external disturbances on the payload 12.

It should be noted that in the implementation illustrated in FIGS. 1A-1E, the supports 36 and the actuators 40 are directly secured to the payload 12. Alternatively, the vibration reduction assembly 24 can include a second connector frame (not shown in FIGS. 1A-1E) that couples (and secures) the supports 36 and/or the actuators 40 to the payload 12.

Further, in the implementation illustrated in FIGS. 1A-1E, the low-stiffness supports 36 are arranged in parallel to three perpendicular axes and/or the actuators 40 are arranged parallel to three perpendicular axes.

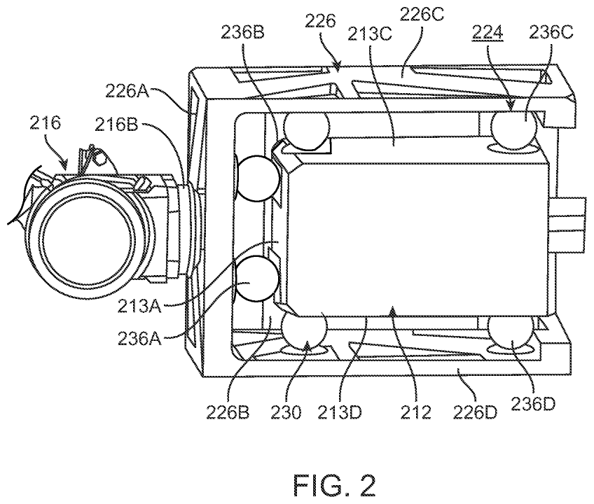

FIG. 2 is a simplified perspective view of another embodiment of (i) a portion of the robot 216 including the mount 2168; (ii) the connector frame 226 at the mount 2168; (ii) the payload 212; and (iii) the vibration reduction assembly 224. In this implementation, the connector frame 226, the payload 212, and the vibration reduction assembly 224 are very similar, but slightly different from the corresponding components described above.

In this embodiment, the vibration reduction assembly 224 includes the support system 230 and not the actuator system. However, this design can be modified to include the actuator system.

In FIG. 2, the support system 230 includes multiple supports 236A-236D for one or more of payload sides 213A, 213C, 213D. For example, the support system 230 can be designed to have (i) two, spaced apart first supports 236A that extends between the first frame side 226A and the first payload side 213A; (ii) four spaced apart second supports 236B (only one is partly visible) that extend between the second frame side 226B and the second payload side (not visible); (iii) two, spaced apart third supports 236C that extends between the third frame side 226C and the third payload side 213C; and (iv) two, spaced apart fourth supports 236D that extends between the fourth frame side 226D and the fourth payload side 213D. In this design, two sides of the payload 212 are not engaged with the support system 230. This configuration allows controlling the rotational stiffness of the vibration reduction assembly 224.

In this design, the supports 236A-236D can be similar to the corresponding components described above, and the support adjuster 34 (illustrated in FIG. 1A) can be controlled to individually control the pressure in each of the supports 236A-236D.

In the implementation of FIG. 2, the supports 236A-236D are directly secured to the payload 212. Alternatively, the vibration reduction assembly 224 can include a second connector frame (not shown in FIG. 2) that couples (and secures) the supports 236A-236D to the payload 12.

In the implementation of FIG. 2, the connector frame 226 does not encircle the payload 212.

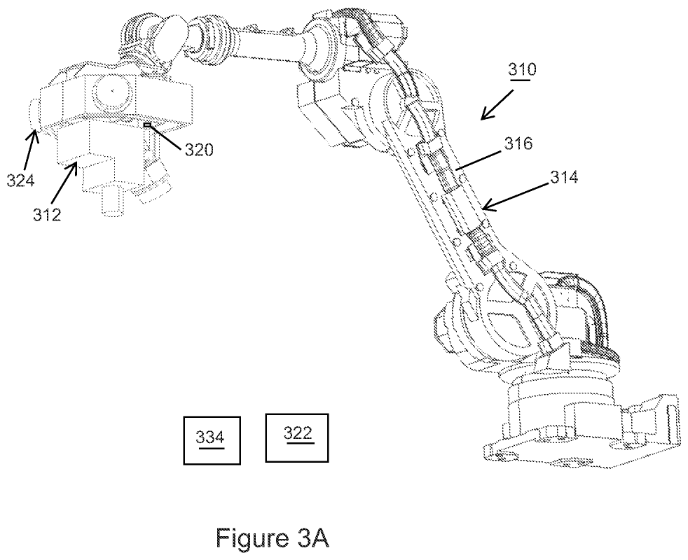

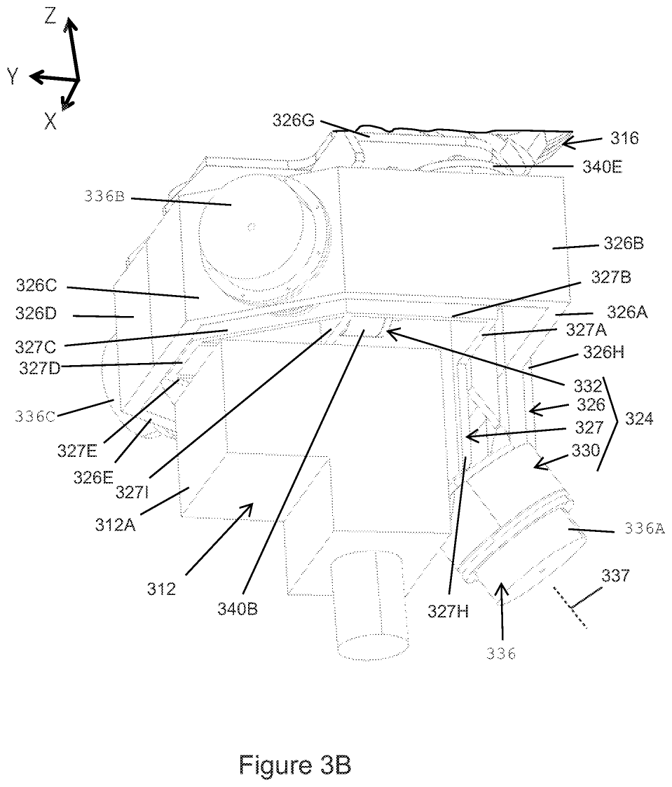

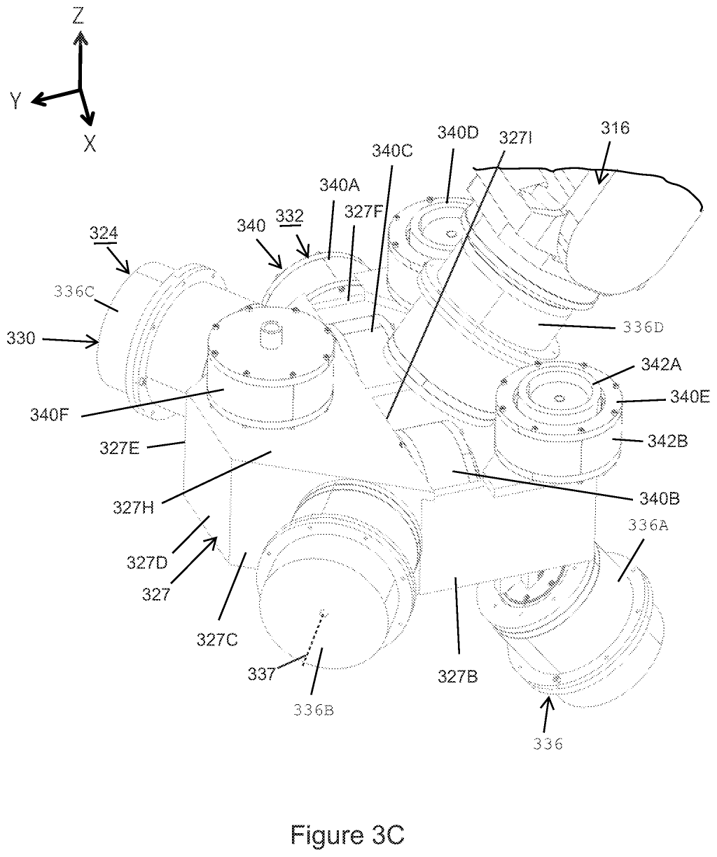

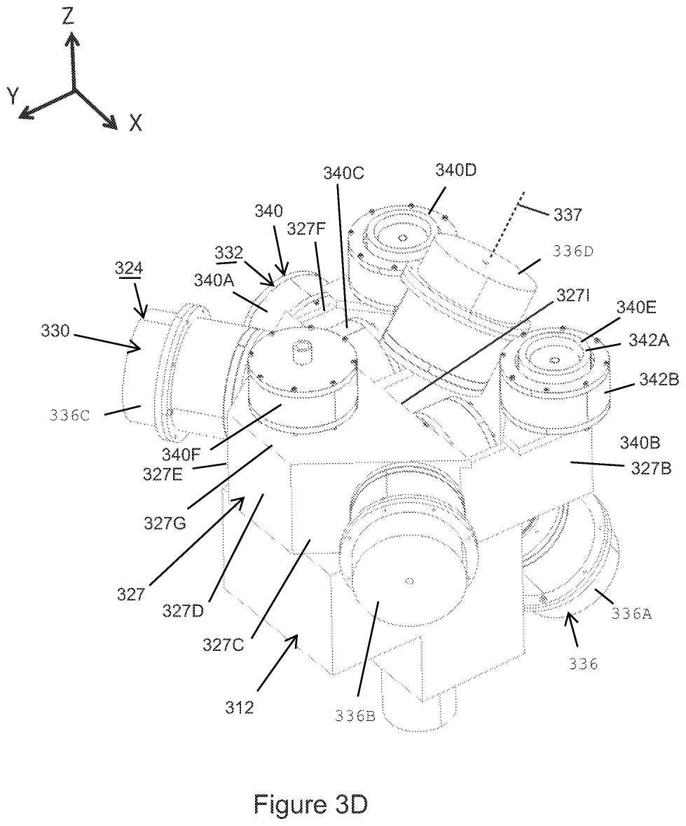

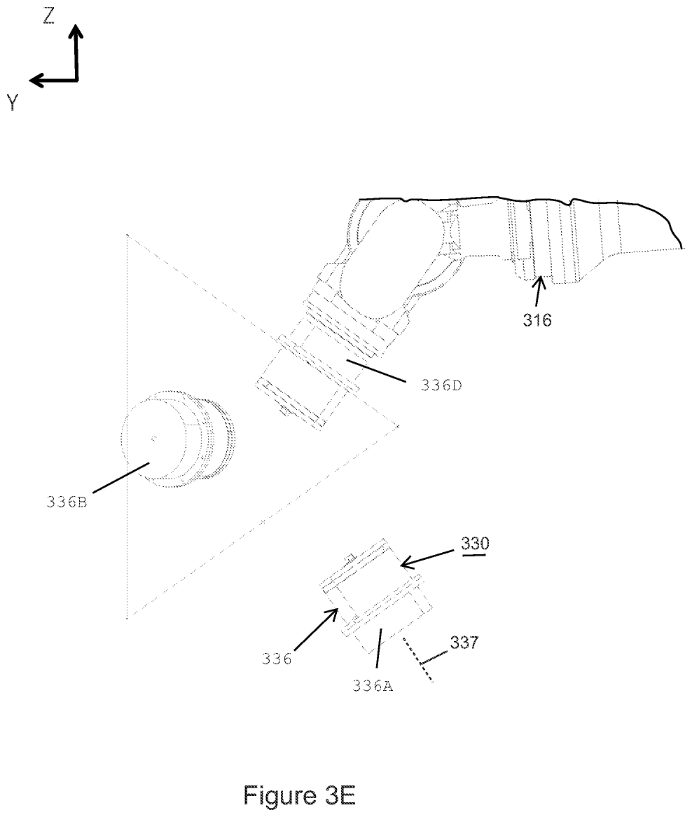

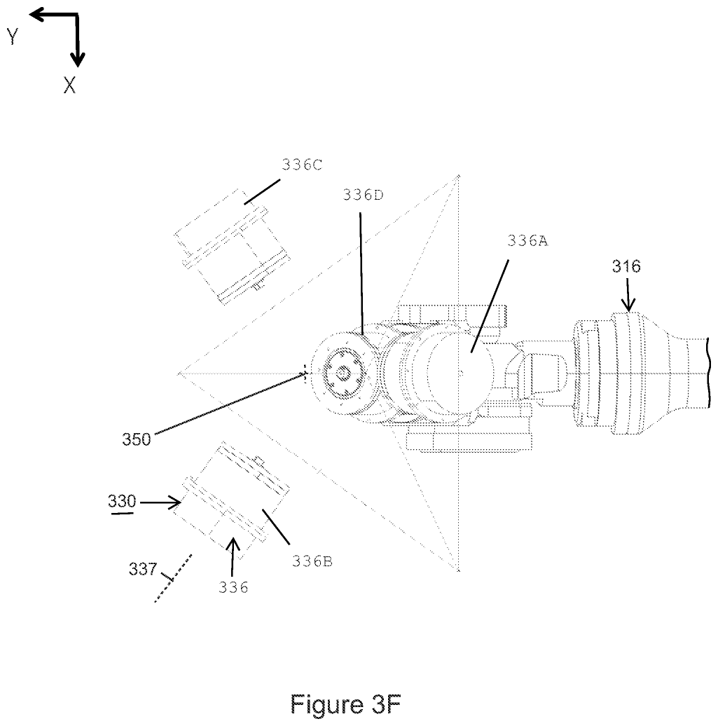

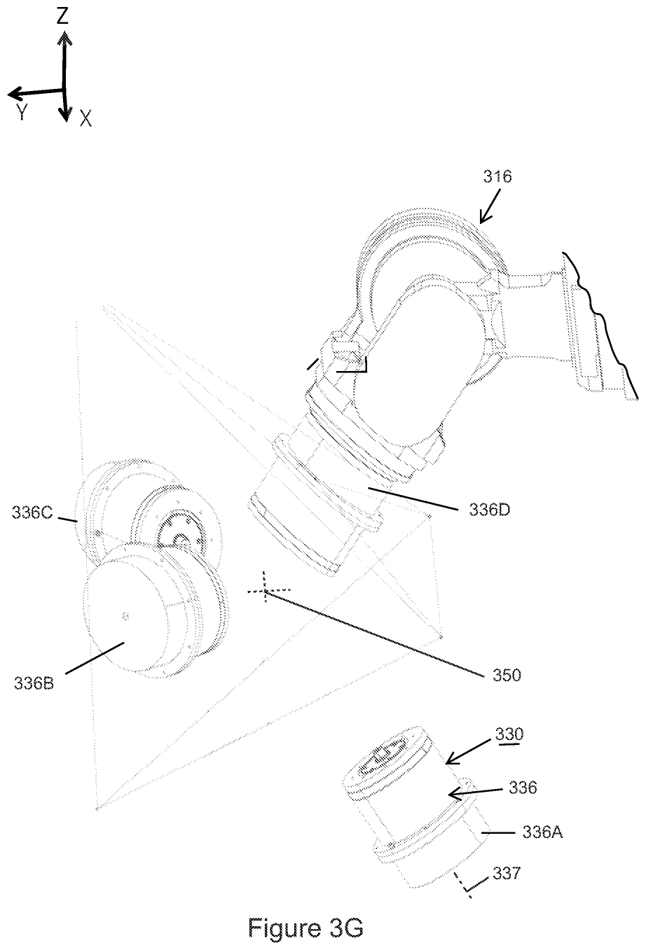

FIG. 3A is a simplified perspective view of another implementation of a machine 310 that includes a payload 312, and a robotic assembly 314 that includes a robot 316, a sensor assembly 320 (illustrated as a box), a control system 322 (illustrated as a box), and a vibration reduction assembly 324. In this implementation, the robot 316, the sensor assembly 320 and the control system 322 are similar to the corresponding components described above and illustrated in FIGS. 1A-1E. However, in this implementation, the payload 312, and the vibration reduction assembly 324 are slightly different. In this implementation, the vibration reduction assembly 324 is again uniquely designed to inhibit vibration in the assembly 314 and/or the support 18 (illustrated in FIG. 1A) from being transferred to the payload 312.

As alternative, non-exclusive examples, the vibration reduction assembly 324 can be used in a conventional processing machine (e.g. a laser processing machine or a machine tool such as a machining center), a transport machine, or any of the machines described herein. In this design, the payload 312 can be referred to as an object. It should be noted that the payload 312 can be considered to be part of a machine, as described above.

FIG. 3B is a perspective view of the payload 312, the vibration reduction assembly 324, and a portion of the robot 316 of FIG. 3A. In this implementation, the payload body 312A has a polygonal cross-sectional shape. Further, the vibration reduction assembly 324 connects the payload 312 to the robot 316, and the vibration reduction assembly 324 does not encircle the payload 312. Thus, the same vibration reduction assembly 324 design can be used with many different payloads 312 (or other objects), and it is easier to attach and detach the payload 312 to the vibration reduction assembly 324.

In the implementation of FIG. 3B, the vibration reduction assembly 324 includes a first connector frame 326, a second connector frame 327, an actively controlled low stiffness support system 330, and an actively controlled actuator system 332. Alternatively, for example, the vibration reduction assembly 324 can be designed without the actuator system 332.

In this design, the first connector frame 326 can attach the vibration reduction assembly 324, the second connector frame 327, and the payload 312 to the robot 316. Stated in another fashion, the first connector frame 326, the vibration reduction assembly 324, the second connector frame 327, and the payload 312 can function as a module that can be selectively added to the robot 316 or another processing machine.

It should also be noted that the first connector frame 326 can alternatively be discussed as being a part of the robot 316, and the second connector frame 327 can be discussed as being a part of the payload 312. Still alternatively, the second connector frame 327 can be eliminated, and the support system 330 and the actuator system 332 can be directly attached to the payload body 312A.

The first connector frame 326 provides a rigid structure for (i) supporting the support system 330 and the actuator system 332, (ii) connecting the support system 330 and the actuator system 332 to the robot 316, and (iii) properly positioning the support system 330 and the actuator system 332 for vibration reduction of the payload 312. The design of the first connector frame 326 can be varied according to the design of the support system 330 and the actuator system 332.

In FIG. 3B, the first connector frame 326 is somewhat open, polygonal frame shaped and includes six rigid sides, which can be labeled (i) a first frame side 326A, (ii) a second frame side 326B, (iii) a third frame side 326C, (iv) a fourth frame side 326D, (v) a fifth frame side 326E, and (vi) a sixth frame side (not visible in FIG. 3B); and a top frame side 326G for convenience of discussion. In this example, (i) the top frame side 326G is connected to the robot 316, and (ii) the first frame side 326A includes a cantilevering region 326H for retaining a portion of the support system 330.

The design of the second connector frame 327 can also be varied according to the design of the support system 330 and the actuator system 332. FIG. 3C is a perspective view of a portion of the robot 316, and the vibration reduction assembly 324 without the first connector frame 326 (illustrated in FIG. 3B). FIG. 3D is a perspective view of the payload 312, and the vibration reduction assembly 324 without the first connector frame 326 (illustrated in FIG. 3B).

With reference to FIGS. 3B-3D, the second connector frame 327 provides a rigid structure for supporting and connecting the support system 330 and the actuator system 332 to the payload 312. The design of the second connector frame 327 can be varied according to the design of the support system 330 and the actuator system 332. In one, non-exclusive implementation, the second connector frame 327 is somewhat open, polygonal frame shaped and includes six rigid sides, which can be labeled (i) a first wall 327A, (ii) a second wall 327B, (iii) a third wall 327C, (iv) a fourth wall 327D, (v) a fifth wall 327E, and (vi) a sixth wall 327F; and a top wall assembly 327G for convenience of discussion. In this example, (i) the top wall assembly 327G includes a plurality of spaced apart pads, and (ii) the first wall 327A includes a cantilevering region 327H for retaining a portion of the support system 330. Moreover, the second connector frame 327 can include an intermediate wall 3271.

With this design, because the support system 330 and the actuator system 332 are directly secured to the second connector frame 327 instead of the payload 312, the payload 312 can be easily attached or detached from the vibration reduction assembly 326. Further, the payload 312 can be changed/replaced easily without interfering with the vibration reduction assembly 326.

FIG. 3E is a side view of a portion of the robot 316 and the support assembly 330. FIG. 3F is a bottom view of a portion of the robot 316 and the support assembly 330. FIG. 3G is a perspective view of a portion of the robot 316 and the support assembly 330. It should be noted that FIGS. 3E-3G each include a triangular or tetrahedral outline to illustrate the positioning of the support assembly 330. This outline is not part of the design.

With reference to FIGS. 3B-3G, the actively controlled low-stiffness support system 330 extends between the first connector frame 326 and the second connector frame 327. Further, the support system 330 supports the mass of the second connector frame 327 and the payload 312 and isolates the payload 312 from high frequency external disturbances.

In the non-exclusive implementation in FIGS. 3B-3G, the support system 330 includes four spaced apart, low-stiffness supports 336 that each extend between the first connector frame 326 and the second connector frame 327. In this design, the four pneumatic supports 336 are arranged in a tetrahedron based configuration pointed at a payload center of gravity 350 (illustrated with a small dashed cross in FIGS. 3F and 3G). The payload center of gravity 350 is the center of gravity of the entire payload, including (in this example) the payload 312, the second connector frame 327, the portion (e.g. the movable members) of the pneumatic supports 336 that are secured to the second connector frame 327, and the portion of the actuators 340 that are secured to the second connector frame 327. For example, each support 336 can have its own alignment axis 337. In the tetrahedron based configuration, the second connector frame 327 is designed to retain the supports 336 so that the alignment axis 337 of each support 336 is perpendicular to a different face of the imaginary tetrahedron, and each alignment axis 337 extends through the payload center of gravity 350. In this implementation, the second connector frame 327 is designed so that each of the supports 336 is positioned so that their force is perpendicular to a separate one of the faces of the imaginary tetrahedron. More specifically, (i) the first support 336A is positioned to direct its force perpendicular to a first face of the imaginary tetrahedron and through the payload center of gravity 350; (ii) the second support 336B is positioned to direct its force perpendicular to a second face of the imaginary tetrahedron and through the payload center of gravity 350; (iii) the third support 336C is positioned to direct its force perpendicular to a third face of the imaginary tetrahedron shape and through the payload center of gravity 350; and (iv) the fourth support 336D is positioned to direct its force perpendicular to a fourth face of the imaginary tetrahedron and through the payload center of gravity 350. In this design, aligning the axes 337 perpendicular to the faces of the imaginary tetrahedron ensures that the supports 336 are oriented so that an angle between any two supports 336 is the same. In should be noted that the supports 336 do not have to be located at the faces of the imaginary tetrahedron, and that the location of the tetrahedron is irrelevant. Instead, the alignment axis 337 of each of the supports 336 needs to be perpendicular to the faces of tetrahedron. In other words, the imaginary tetrahedron is a way to establish the angular orientation of each support 336. In summary, with this design, effectively, the alignment axis 337 of the supports 336 are oriented towards a single location (e.g. the payload center of gravity 350). As a result thereof, the four support 336 are symmetrically positioned and their forces act through the payload center of gravity 350. With this design, the location of the imaginary tetrahedral will vary according to the location of the payload center of gravity 350.

Alternatively, the payload center of gravity 350 may be located out of the center of the tetrahedron or may be located within the bounds of the tetrahedron. However, it should be noted that the supports 336 may be configured in other arrangements other than tetrahedron. For example, if the number of supports 336 is greater than four, the supports 336 can be configured with their axes 337 perpendicular to the faces of a polyhedron with that number of faces. In other examples, the supports 336 can be configured so the angles between them are not equal, but vary by an amount less than 10, 20, 30, or 50 percent.

For convenience, these supports 336 can be labeled (i) a first support 336A that extends between the first frame side 326A of the first connector frame 326 and the first wall 327A of the second connector frame 327; (ii) a second support 336B that extends between the third frame side 326C of the first connector frame 326 and the third wall 327C of the second connector frame 327; (iii) a third support 336C that extends between the fifth frame side 326E of the first connector frame 326 and the fifth wall 327E of the second connector frame 327; and (iv) a fourth support 336D that extends between the top frame side 326G of the first connector frame 326 and the top wall assembly 327G of the second connector frame 327.

The design of each support 336 can be similar to the pneumatic supports 36 described above. Further, one or more (e.g. each) of the supports 336 can include a pressure sensor (not shown) which senses the pressure of the pneumatic fluid in the respective pneumatic chamber.

With this design, the pressure sensor for each support 336 can provide feedback regarding the pressure in each support 336 to the control system 322 (illustrated in FIG. 3A), and the control system 322 can actively control the support adjuster 334 (illustrated in FIG. 3A) to individually and actively adjust and control the pressure in each support 336. This active control of the pressure also actively controls the force produced by each support 336.

As a result thereof, an external disturbance transferred to the first connector frame 326 will cause the first connector frame 326 to move. The movement of the connector frame 326 relative to the second connector frame 327 will cause the pressure in the supports 336 to change (fluctuate). The pressure sensors can detect these changes, and the feedback is used to control the support adjuster 334 to individually control the pressure in each support 336 (e.g. minimize pressure fluctuation) to inhibit the external disturbance from being transmitted to the second connector frame 327 and thereby to payload 312.

Somewhat similarly, the optional, actively controlled, actuator system 332 extends between the first connector frame 326 and the second connector frame 327. In the non-exclusive implementation in FIGS. 3B-3C, the actuator system 332 includes six spaced apart actuators 340 that each extend between the first connector frame 326 and the second connector frame 327. For convenience, these actuators 340 can be labeled (i) a first actuator 340A which extends along the X axis between the sixth wall 327F of the second connector frame 327 and sixth frame side 326F of the first connector frame 326; (ii) a second actuator 340B and a third actuator 340C which extend along the Y axis between the intermediate wall 3271 of the second connector frame 327 and the first connector frame 326; and (iii) a fourth actuator 340D, a fifth actuator 340E, and a sixth actuator 340F which extend along the Z axis between the top wall assembly 327G of the second connector frame 327 and the top frame side 326G of the first connector frame 326

In this design, (i) the first actuator 340A generates a controllable force along the X axis on the second connector frame 327; (ii) the second actuator 340B and the third actuator 340C each generate a separate, individually controllable force along the Y axis on the second connector frame 327; and (iii) the fourth actuator 340D, the fifth actuator 340E, and the sixth actuator 340F each generate a separate, individually controllable force along the Z axis on the second connector frame 327.

Further, the Y axis forces generated by the second actuator 340B and the third actuator 340C are spaced apart along the X axis, and thus the Y axis forces can be used to generate a controllable rotational force on the payload 12 about the Z axis. Moreover, the Z axis forces generated by the fourth actuator 340D, the fifth actuator 340E, and the sixth actuator 340F are spaced apart and can be used the generate a controllable rotational force on the payload 12 about the X axis and about the Y axis. With this design, the actuators 340 can be controlled to position the second connector frame 327 and the payload 312 with six degrees of freedom.

The design of each actuator 340 can be somewhat similar to the corresponding components described above. In one non-exclusive implementation, each actuator 340 is a voice coil actuator that includes (i) a first actuator component 342A that is secured to the first connector frame 326; and (ii) a second actuator component 342B that is secured to the second connector frame 327. In this design, one of the actuator components 342A, 342B can include a magnet array, and the other actuator components 342B, 342A can include a conductor array. For example, the conductor array can be annular shaped, and the magnet array can include a pair of spaced apart, annular shaped magnet sets (not shown).

With this design, the sensor assembly 320 (illustrated in FIG. 3A) can provide feedback regarding the position of the payload 312 and/or the position of the movable part, and/or inertial reference locations to the control system 322 (illustrated in FIG. 3A), and the control system 322 can actively control (direct current) to the actuators 340 to individually and actively adjust the force generated by each actuator 340. This active control of the force by each actuator 340 can be used to rapidly maintain the position of the payload 312 under the control of the control system 322.

As provided herein, with reference to FIGS. 1A, 2 and 3A, as the robot 16, 216, 316 rotates the payload 12, 212, 312 into the many different orientations, the control system 22, 322 can calculate the required force from each support 36, 236, 336 to counteract the forces of gravity acting on the payload 12, 212, 312. The pressure supplied to each support 36, 236, 336 is varied by the electronic regulators of the support adjuster 34, 334 to match the calculated amount. The control system 22, 322 can also calculate the forces needed to provide desired acceleration to the payload.

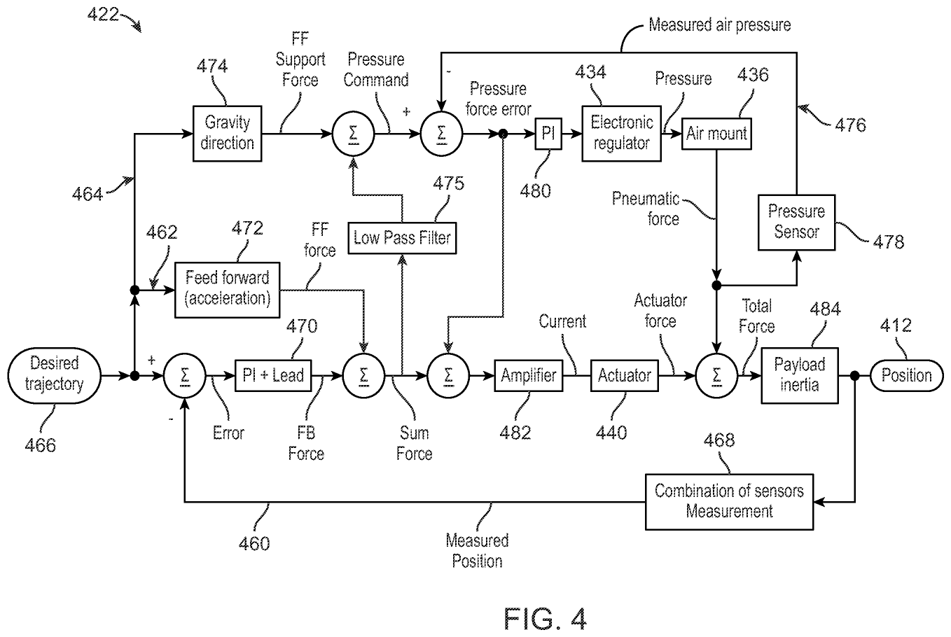

The design of the control system 22, 322 can be varied to achieve the desired characteristics of the vibration reduction assembly 24, 224, 324. In one non-exclusive implementation, the control system 22, 322 may be implemented according to the control block diagram 422 shown in FIG. 4 to control the vibration reduction assembly 24, 324 to precisely position the payload 12, 312. With reference to FIG. 4, two features of the control block diagram 422 are that (i) the actuators 440 are used to correct for the measured error in the force generated by the supports 436; and (ii) the constant and low frequency components of the actuator forces generated by the actuators 440 are fed-forward to the support adjuster 434 for adjustment (control) of the supports 436.

In FIG. 4, the control block diagram 422 includes a feedback control loop 460, a feedforward control path 462, and a low-stiffness support compensation path 464. Starting at the left side of the block diagram 422, the desired trajectory (along the X, Y, and Z axes, and about the X, Y, and Z axes) of the payload 412 at a particular moment in time is directed at block 466.

For the feedback control loop 460, the actual (measured) position 468 of the payload 412 is measured by the sensor assembly 20, 320 (illustrated in FIGS. 1A, 3A). The actual position 468 is compared to the desired trajectory 466 and an error signal is generated. The error signal can be fed into a feedback controller 470 (e.g. a PI+Lead controller) to generate a feedback force (“FB Force”) command along and about the X, Y and/or Z axes that are necessary to correct the following error (e.g. the forces necessary to move the payload 412 to the desired trajectory).

For the feedforward control path 462, the desired trajectory 466 is fed into a feedforward controller 472 (e.g. the sum of signals proportional to the desired acceleration and velocity) to generate a feedforward force (“FF Force”) command along and about the X, Y and/or Z axes.

The feedforward force command is summed with the feedback force command to create a summed force command (“Sum Force”).

For the low-stiffness support compensation loop 464, the desired trajectory 466 is fed into a feedforward controller 474 (e.g. a kinematic calculation of the expected gravity direction) to generate a feedforward support force (“FF Support Force”) command for the low-stiffness supports 436 along and about the X, Y and/or Z axes that are necessary to compensate for the effects of gravity on the payload 412. Next, the summed force command from the feedback control loop 460 and the feedforward path 462 is directed through a low-pass filter 475 and combined with the feedforward support force command, and a pressure command for the low-stiffness supports 30, 330 is generated.

In the example of FIG. 4, the low-stiffness support compensation loop 464 includes a support feedback loop 476. In this loop 476, at block 478 the pressure in each low-stiffness support 436 is measured. The measured air pressure signal is combined with the pressure command to generate a pressure force error. Next, the pressure force error is directed to a support controller 480 (e.g., a PI controller), which controls the support adjuster (i.e. an electronic regulator) 434 that controls the pressure in the supports 436. The pressure in the supports 436 generates a pneumatic force for each support 436 on the payload 412.

Returning to the feedback control loop 460, the pressure force error from the low-stiffness support compensation loop 464 is combined with the summed force command and directed to an amplifier 482 which determines the electrical current that is directed to the actuators 440 to generate an actuator force for each actuator 440 on the payload 412.

With this design, the actuator force and the pneumatic force apply a total force on the payload 412 that can move the payload 412 according to the desired trajectory. Block 484 represents how the inertia of the payload 412 determines the position of payload 412 as a function of the total applied force.

It should be noted that because the pressure force error from the low-stiffness support compensation loop 464 is directed to the feedback control loop 460, the actuators 440 are used to correct for the measured error (air pressure error) in the force generated by the supports 436. In particular, this allows the faster response of the actuators 440 to compensate for the relatively slow response of the pneumatic pressure control of supports 436. Further, because the summed force from the feedback control loop 460 is fed-forward through low pass filter 475 to the low-stiffness support compensation loop 464, the supports 436 are used to adjust for the constant and low frequency components of the actuator forces generated by the actuators 440, thereby reducing power consumption, heat dissipation, and other effects in actuators 440. As used herein, in certain implementations, low frequency shall mean a frequency of less than 1, 3, 5, 8, or 10 hertz.

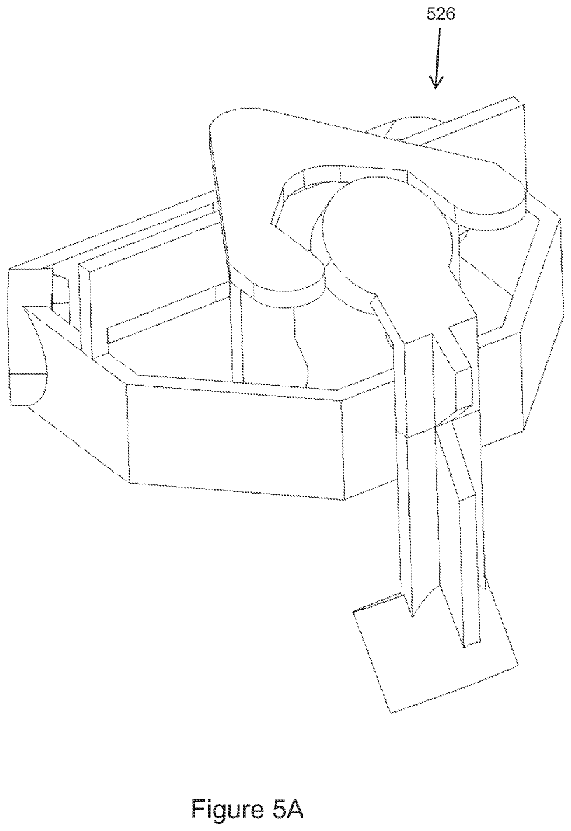

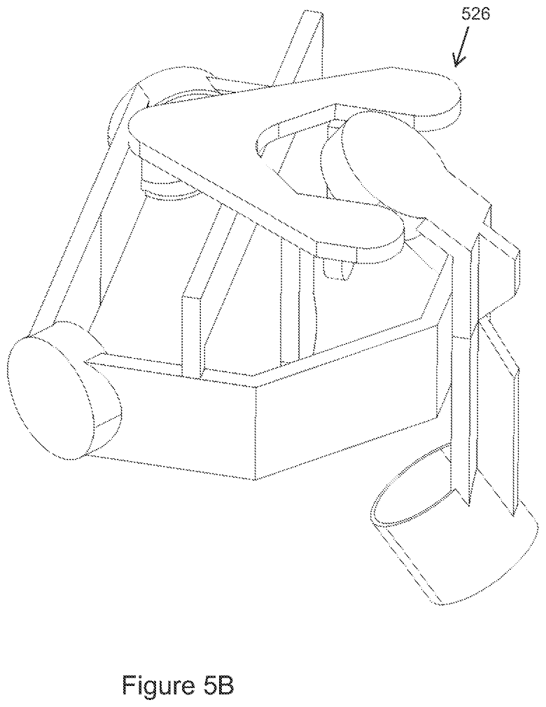

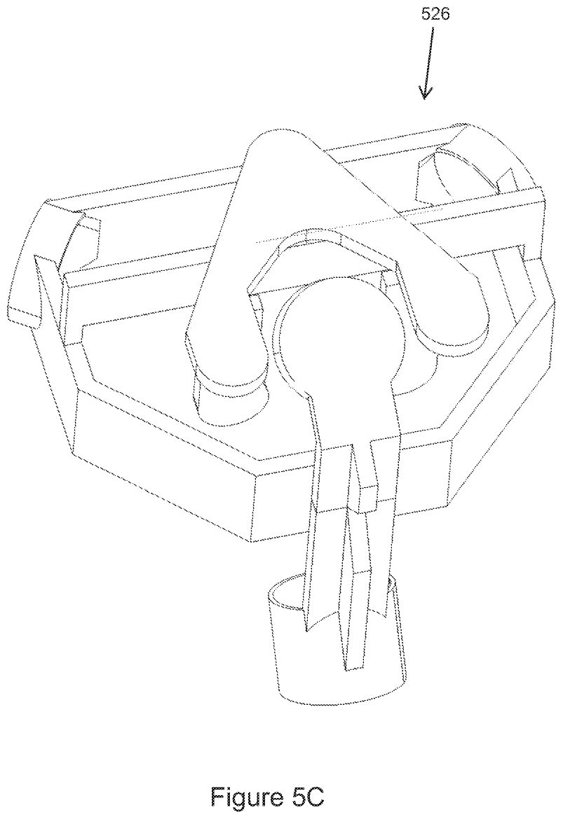

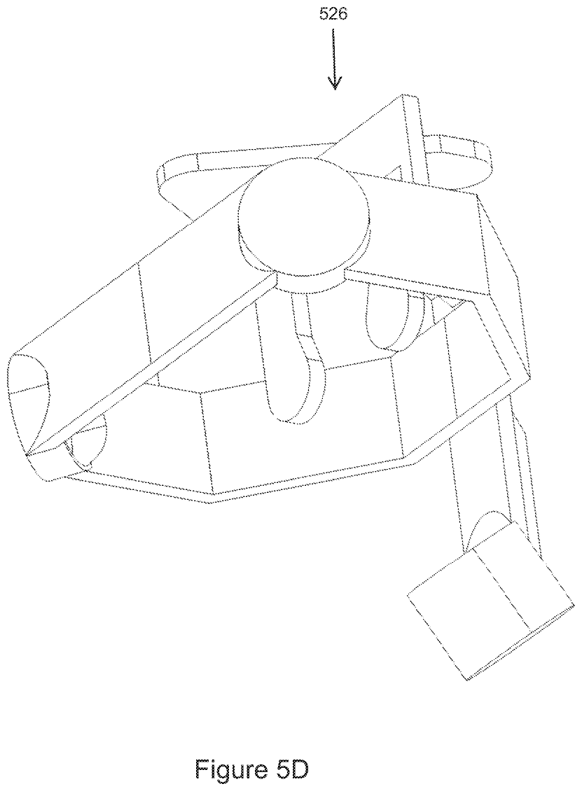

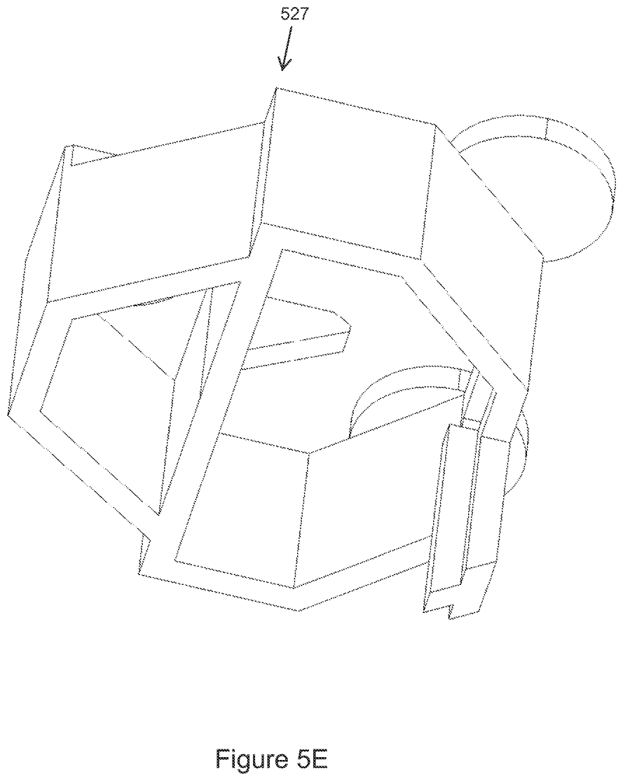

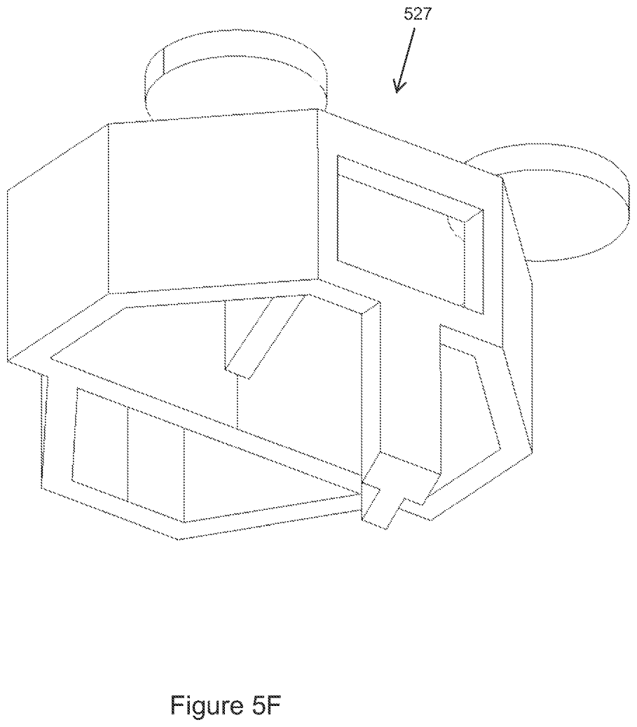

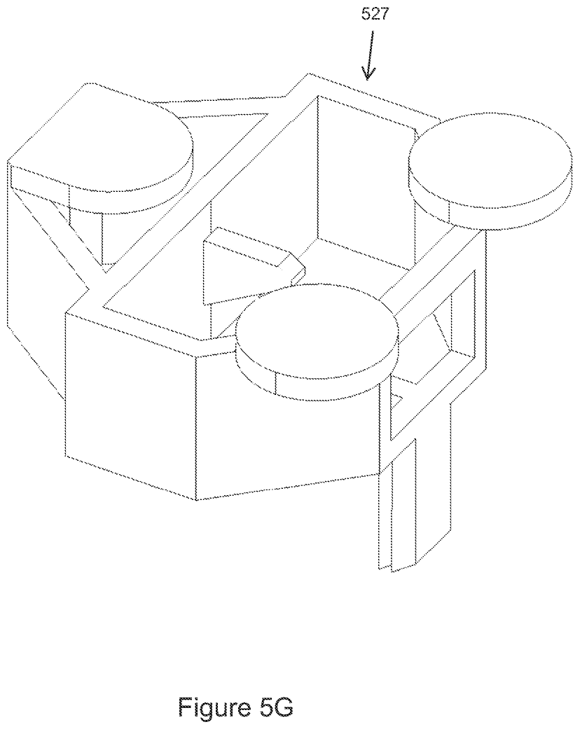

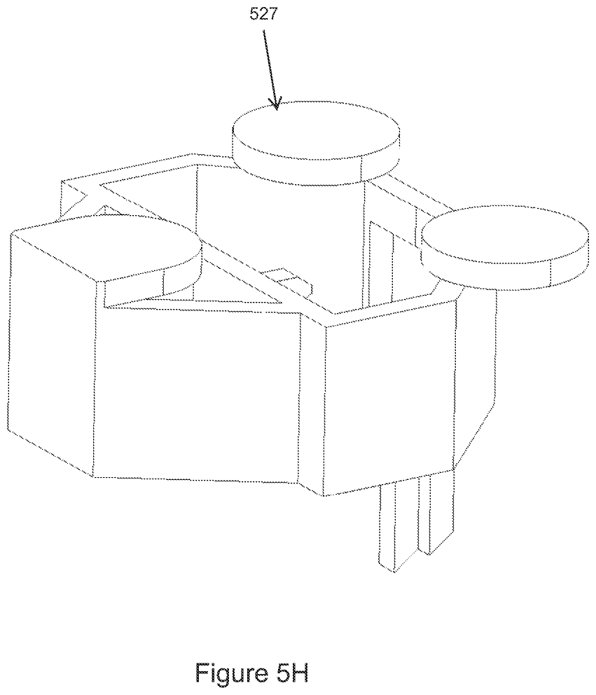

FIGS. 5A-5D are alternative perspective views of another, different implementation of the first connector frame 526, and FIGS. 5E-5H are alternative perspective views of the corresponding second connector frame 527. It should be noted that the illustrated connector frames 526, 527 are slightly different in shape than the corresponding components described above and illustrated in FIG. 3B. However, in FIGS. 5A-5D, the connector frames 526, 527 are again designed to be connected by the supports 336 (illustrated in FIG. 3B) in a tetrahedron configuration and the actuators 340 (illustrated in FIG. 3B).

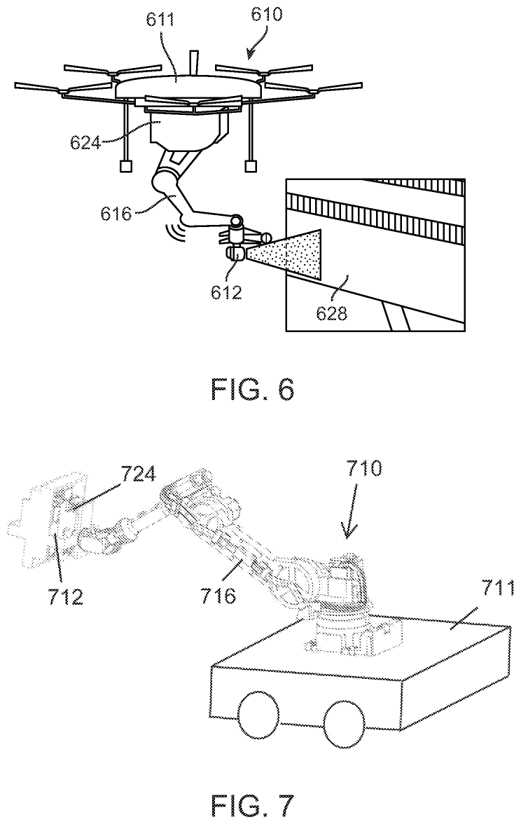

FIG. 6 is a simplified side view of another implementation of a machine 610. In this implementation, the machine 610 includes a vehicle 611 (e.g. an Automatically Guided Vehicle (AGV) or an aerial drone), a robotic arm 616, and a vibration reduction assembly 624 (illustrated as a box) that couples the robotic arm 616 to the aerial vehicle 611. The vibration reduction assembly 624 can be similar to the corresponding assembly described above, and the vibration reduction assembly 624 inhibits vibration from the aerial vehicle 611 from being transferred to the robotic arm 616 and the payload 612 being positioned by the machine 610. In FIG. 6, the payload 612 is a laser that directs a beam at a target surface 628. Alternatively, the machine 610 position another type of payload 612. Further, the vehicle 611 can be another type of vehicle, such as a water, underwater, or amphibious vehicle.

FIG. 7 is a simplified side view of still another implementation of a machine 710. In this implementation, the machine 710 includes a vehicle 711 (e.g. an automatically or driven cart), a robotic arm 716 that is moved by the vehicle 711, and a vibration reduction assembly 724 that couples a payload 712 to the robotic arm 716. The vibration reduction assembly 724 can be similar to the corresponding assembly described above, and the vibration reduction assembly 724 inhibits vibration from the vehicle 711, the surface (not shown) that support the vehicle 711, and the robotic arm 716 from being transferred to the payload 712.

It should be noted that the vibration reduction assemblies disclosed herein can be used with other machines.

As will readily be appreciated by those of normal skill in the art, the configuration and/or shape of the payload 12, 212, 312, 412 may be varied depending on the requirements and goals of each particular application. Likewise, the type and configuration of the supports 36, 236, 336, 436 and/or the actuators 40, 240, 340, 440 may be varied. For omnidirectional support, a minimum of four supports 36, 236, 336, 436 is needed for supports (like the supports 36) that can only generate force in one direction (i.e., they can “push” but not “pull” because the internal air pressure is always greater than the ambient pressure). For an omnidirectional system utilizing supports 36, 236, 336, 436 that can produce both positive and negative forces, the minimum number of supports is three. For applications where the motion of the payload 12, 212, 312, 412 is restricted to a limited range of orientation relative to gravity, fewer supports 36, 236, 336, 436 may be used. In a similar way, a minimum of six actuators 40, 240, 340, 440 is needed for control in six degrees of freedom (6DOF). In some applications the motion of payload 12, 212, 312, 412 may not require full 6DOF control and fewer actuators 40, 240, 340, 440 may be used. Furthermore, it is always possible to use more supports 36, 236, 336, 436 and/or actuators 40, 240, 340, 440 than these minimum numbers.

It is understood that although a number of different embodiments of the machine have been illustrated and described herein, one or more features of any one embodiment can be combined with one or more features of one or more of the other embodiments, provided that such combination satisfies the intent of the present disclosure.

Further, while a number of exemplary aspects and embodiments of the machine have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

1. (canceled)

2.-67. (canceled)

68. A machine for positioning an object, the machine comprising:
a movable part; and
a vibration reduction system having at least one actuator located between the object and the movable part, wherein the at least one actuator reduces a magnitude of a vibration transferred from the movable part to the object so as to be less than another magnitude of vibration transferred from the movable part to the vibration reduction system.

69. The machine of claim 68, wherein the movable part is a link in a robot that includes a link actuator that moves the link.

70. The machine of claim 68, wherein the movable part is a link in a multiple degree of freedom robotic arm, and the at least one actuator is movable in multiple degrees of freedom to reduce the vibration.

71. The machine of claim 68, wherein the movable part is a component of at least one of a mobile robotic vehicle, a mobile vehicle, an aerial drone, and a vehicle.

72. The machine of claim 68, further comprising at least one low-stiffness support that connects the object to the movable part.

73. The machine of claim 72, wherein the at least one low-stiffness support includes one of a spring, a bellows, and a pneumatic chamber.

74. The machine of claim 68, further comprising a plurality of spaced apart low-stiffness supports that connect the object to the movable part.

75. The machine of claim 74, wherein respective forces produced by each low-stiffness support of the at least one low-stiffness support is directed through a center of gravity of the object.

76. The machine of claim 74, wherein the at least one low-stiffness support comprises a plurality of low-stiffness supports arranged parallel to three perpendicular axes.

77. The machine of claim 74, wherein the at least one low-stiffness support comprises a plurality of low-stiffness supports arranged in a tetrahedron configuration.

78. The machine of claim 72, further comprising a control system that actively controls a force produced by each low-stiffness support of the at least one low-stiffness support.

79. The machine of claim 77, wherein at least one actuator includes a plurality of spaced apart actuators that connect the object to the movable part.

80. The machine of claim 77, wherein at least one support and at least one actuator act in parallel.

81. The machine of claim 68, further comprising a sensor assembly that provides feedback, and a control system that actively controls the at least one actuator to inhibit vibration in the movable part from being transferred to the object.

82. The machine of claim 68, wherein the movable part is one of
a component of a processing machine, or
a component of a laser processing machine, and the object is at least a portion of a laser device.

83. A robotic assembly for positioning a payload, the robotic assembly comprising:
a robot including a link and a link actuator that moves the link; and
at least one actuator located between a payload and the robot that reduces a magnitude of a vibration transferred from the robot to the payload to be less than another magnitude of vibration transferred from the robot to the at least one actuator.

84. The robotic assembly of claim 83, wherein the link is part of a multiple degree of freedom robotic arm, and wherein the at least one actuator is movable in multiple degrees of freedom to reduce the vibration.

85. The machine of claim 83 wherein the movable part is one of a mobile robotic vehicle, a mobile vehicle, an aerial drone, and a vehicle.

86. The robotic assembly of claim 83 further comprising at least one low-stiffness support that connects the payload to the robot.

87. The robotic assembly of claim 86 wherein the at least one low-stiffness support includes one of a spring, a bellows, and a pneumatic chamber.

88. The robotic assembly of claim 83 further comprising a plurality of spaced apart low-stiffness supports that connect the payload to the robot.

89. The robotic assembly of claim 88, further comprising a control system that actively controls a force produced by each low-stiffness support of the at least one low-stiffness support.

90. The robotic assembly of claim 89, wherein respective forces produced by each low-stiffness support is directed through a center of gravity of the payload.

91. The machine of claim 89, wherein the at least one low-stiffness support comprises a plurality of low-stiffness supports arranged parallel to three perpendicular axes.

92. The robotic assembly of claim 89, wherein the at least one low-stiffness support comprises a plurality of low-stiffness supports arranged in a tetrahedron configuration.

93. The robotic assembly of claim 92, wherein the at least one actuator includes a plurality of spaced apart actuators that connect the object to the movable part.

94. The robotic assembly of claim 92, wherein the at least one low-stiffness support and an actuator of the at least one actuator act in parallel.

95. The robotic assembly of claim 83, further comprising a sensor assembly that provides feedback, and a control system that actively controls the at least one actuator to reduce a magnitude of a vibration being transferred from the robot to the payload.

96. An assembly that couples an object to a movable part, the assembly comprising:
a plurality of spaced apart low-stiffness supports that connect the object to the movable part;
a sensor assembly that provides feedback; and
a control system that actively controls the low-stiffness supports so as to reduce a magnitude of a vibration transferred from the movable part to the object using the feedback, the reduction in magnitude of vibration being relative to a magnitude of vibration imparted on the plurality of low-stiffness supports by the movable part.

97. The assembly of claim 96, wherein the control system actively controls the low-stiffness supports to reduce the magnitude of a vibration transferred from the movable part to the object with six degrees of freedom.

98. The assembly of claim 96, wherein each support of the plurality of spaced apart low-stiffness supports includes a pneumatic chamber.

99. The assembly of claim 98, wherein the control system actively controls a force produced by each low-stiffness support.

100. The assembly of claim 99, wherein forces produced by each low-stiffness support are directed through a center of gravity of the object.

101. The assembly of claim 99, wherein the low-stiffness supports are arranged in a tetrahedron configuration.

102. The assembly of claim 99, wherein the low-stiffness supports are arranged parallel to three perpendicular axes.

103. The assembly of claim 100, further comprising a plurality of spaced apart actuators that connect the object to the movable part, wherein the control system actively controls the plurality of spaced apart actuators to at least partly inhibit vibration in the movable part from being transferred to the object.

104. The assembly of claim 96, further comprising a first connector frame that is secured to the movable part, and a second connector frame that retains the object, wherein the plurality of spaced apart low-stiffness supports extend between the first connector frame and the second connector frame.

105. A machine comprising:
the assembly of claim 96;
the movable part; and
the object.

106. The machine of claim 105, wherein the movable part is a component of a robot and the object is a payload.

107. The machine of claim 105, wherein the movable part is a component in at least one of a mobile robotic vehicle, a vehicle, and an aerial vehicle.

108. A vibration reduction assembly for reducing a magnitude of a vibration being transferred from a movable part to an object, the vibration reduction assembly comprising:
a plurality of supports which movably connect the movable part to the object;
a sensor assembly that obtains information regarding a sensed condition of the object;
a control system that actively controls the plurality of supports to reduce a magnitude of the vibration being transferred from the movable part to the object.

109. The vibration reduction assembly of claim 108, wherein the movable part is a component of a robot and the object is a payload.

110. A laser machine comprising:
a laser including a laser output;
a robot; and
a vibration reduction assembly that couples the laser output to the robot, the vibration reduction assembly reduces a magnitude of a vibration being transferred from the robot to the laser output.

111. The laser machine of claim 110, wherein the vibration reduction assembly includes at least one low-stiffness support that connects the laser output to the robot.

112. The laser machine of claim 110, wherein the vibration reduction assembly includes a plurality of spaced apart low-stiffness supports that connect the laser output to the robot.

113. The laser machine of claim 112, wherein forces produced by each low-stiffness support are directed through a center of gravity of the object.

114. The laser machine of claim 112, wherein the low-stiffness supports are arranged parallel to three perpendicular axes.

115. The laser machine of claim 112, wherein the low-stiffness supports are arranged in a tetrahedron configuration.

116. The laser machine of claim 112, further comprising a control system that actively controls a force produced by each low-stiffness support.

117. The laser machine of claim 112, wherein the vibration reduction assembly includes at least one actuator that connects the object to the movable part.
